(19) United States
(12) Patent Application Publication
(10) Pub. No.: US 2009/0273228 A1
(43) Pub. Date: Nov. 5, 2009

(54) MOTOR VEHICLE BRAKING INSTALLATION

(75) Inventors: Yannick Nen, Arpajon (FR); Aleksander Hurwic, Paris (FR); Bruno Beylerian, Louvres (FR); Etienne Durand, Paris (FR); Nicolas Marlhe, Marly La Ville (FR); Jean-Marc Piel, Livry Gargan (FR)

Correspondence Address: MICHAEL BEST & FRIEDRICH LLP, 100 EAST WISCONSIN AVENUE, MILWAUKEE, WI, 53202, US

(73) Assignee: ROBERT BOSCH GMBH, Stuttgart (DE)

(21) Appl. No.: 12/440,110

(22) PCT Filed: Aug. 29, 2007
(86) PCT No.: PCT/EP07/58988

§ 371 Date: Mar. 5, 2009

(30) Foreign Application Priority Data
Sep. 8, 2006 (FR) 0607942

(51) Int. Cl. B60T 8/38

(52) U.S. Cl. 303/113.4

(57) ABSTRACT

Motor vehicle braking installation comprising a master cylinder (10) operated by a brake pedal and connected to a brake fluid reservoir (30) and to feed circuits (26, 28) supplying the wheel brakes, characterized in that the brake fluid reservoir (30) is mounted on the master cylinder and is connected to the master cylinder (10) by connecting means (32, 34) involving electrically operated valves (36, 38) which valves are closed in the rest position and are made to open by a computer (C) on the basis of an output signal from a position sensor or displacement transducer (40) associated with the brake pedal or with the said element moved by this pedal.

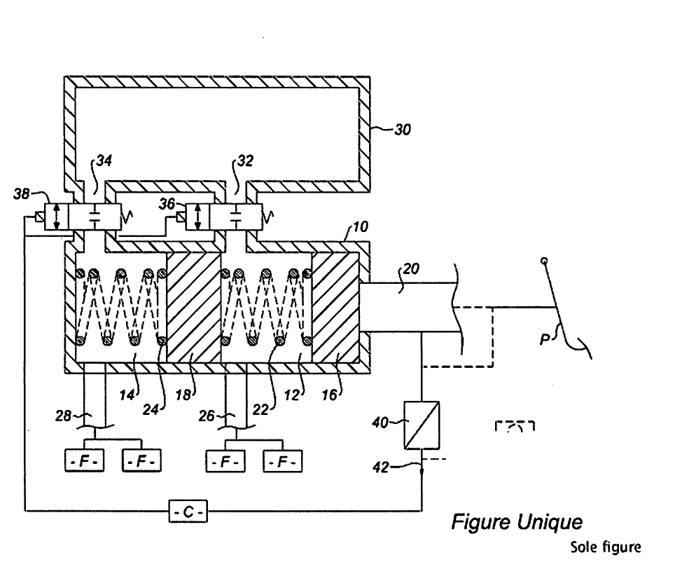

### BACKGROUND AND SUMMARY OF THE INVENTION

This invention concerns a braking installation for a motor vehicle, said installation comprising a master cylinder controlled by a brake pedal and connected to a brake fluid reservoir and feed circuits for the wheel brakes.

In such an installation, braking is controlled essentially by the driver of the vehicle, using the brake pedal which is connected to the piston of the master cylinder by a pneumatic brake booster, and the action of the driver on the brake pedal causes the vehicle to brake.

In these installations, a brake fluid reservoir is conventionally attached to the master cylinder and communicates with each of its chambers via brake-fluid feed and return conduits, the pistons of the master cylinder being fitted with conduits and brake-fluid valves. This known arrangement has the drawback of permitting free travel and increasing the number of components in the master cylinder.

Furthermore, the document FRA1-2 654 816 references a braking system comprising a master cylinder fitted with solenoid valves at the pressure outlet.

This invention is particularly intended to resolve these drawbacks in the prior art.

It concerns an installation of the type detailed above, whose master cylinder has a structure that is simpler than in the prior art and comprises fewer components and in which the free travel is eliminated or at least reduced.

Accordingly, it provides a braking installation for a motor vehicle, comprising a master cylinder controlled by a brake pedal and connected to a brake fluid reservoir and feed circuits for wheel brakes, said installation being characterized in that the brake fluid reservoir is linked to the master cylinder by means of connection means controlled by solenoid valves.

Thanks to this invention, it is no longer necessary to provide conduits or valves for brake fluid in the pistons of the master cylinder whose structure may be considerably simplified, on account of the fact that the links between the chambers of the master cylinder and the reservoir are fitted with solenoid valves controlled by a computer.

This makes it possible, firstly, to reduce or eliminate travel in the master cylinder and, secondly, to install the reservoir on the master cylinder or away from it as required.

In a preferred embodiment of the invention, the master cylinder is a tandem master cylinder and comprises two pumping chambers that are each connected to the reservoir by a solenoid valve, each solenoid valve being open when the brake pedal or an element driven by that pedal is in the idle or non-braking position, and being closed when the brake pedal or that element leaves the idle or non-braking position.

Each of the aforementioned solenoid valves is closed in idle state and opened by the computer on the basis of the output signal of a position or movement sensor linked to the brake pedal or any other element moved by that pedal.

### DETAILED DESCRIPTION

The invention will be better understood and further features, details and advantages thereof will become clearer from the description below, given by way of an example with reference to the attached drawing which is a schematic side-elevation of a master cylinder of a braking installation according to the invention.

In the text below, everything on the left-hand side of the drawing is described as being at the front and everything on the right-hand side is described as being at the rear.

The master cylinder of a braking installation according to the invention, shown in the drawing comprises a cylindrical body 10 in which a primary pumping chamber 12 and a secondary pumping chamber 14 are delimited by a primary piston 16 and a secondary piston 18, the primary piston 16 being linked by a push rod 20 to a pneumatic brake booster, not shown, itself controlled by a brake pedal P.

The return springs 22 and 24 are arranged between the primary piston 16 and the secondary piston 18 and between the secondary piston 18 and the front extremity of the body 10 of the master cylinder, conventionally, and each pumping chamber 12, 14 is linked by a conduit 26, 28 respectively to means of feeding the brakes F fitted on the front wheels and rear wheels of the vehicle.

A brake fluid reservoir 30 is fitted to the body 10 of the master cylinder and communicates with the chambers 12, 14 of it via two passages 32, 34 respectively, each fitted with a solenoid valve 36, 38 respectively.

Each solenoid valve 36, 38 is controlled by a computer C and closed in idle state.

A position or movement sensor 40 is linked to the push rod 20 or another element whose movement is controlled by the action of the driver on the brake pedal, and provides an output signal 42 corresponding to the movement of the push rod 20 and sent to the computer C.

The solenoid valves 36, 38 are opened by the computer, when the primary piston 16 and the secondary piston 18 of the master cylinder are in the idle or non-braking position shown in the drawing, i.e. when the driver is not acting on the brake pedal of the vehicle.

Any movement of the push rod 20 caused by the action of the driver on the brake pedal is detected by the movement sensor 40 and sent to the computer which closes the solenoid valves 36 and 38. Accordingly, any action by the driver on the brake pedal immediately results in an increase in the pressure of the brake fluid in the conduits 26 and 28 supplying the wheel brakes, the travel in the pistons of the master cylinder being eliminated.

This elimination of travel reduces the response time of the braking installation and allows overall braking of the vehicle to be improved. Furthermore, the master cylinder has a structure that is simpler than in the prior art and comprises fewer components. Its assembly is simpler and its cost price is reduced.

The solenoid valves 36 and 38 are opened by the computer to allow the brake fluid to return to the reservoir 30, as required.

In an alternative embodiment, as shown with a dotted line, the sensor 40 may be a position or movement sensor that is conventionally linked to the brake pedal P to control the illumination of the lamps of the brake signal circuits 44 (‘stop lights’) when the driver of the vehicle presses on the brake pedal.

1. Braking installation for a motor vehicle, comprising a master cylinder (10) controlled by a brake pedal and connected to a brake fluid reservoir (30) and circuits (26, 28) feeding the wheel brakes, characterized in that the brake fluid reservoir (30) is fitted to the master cylinder linked by connection means (32, 34) involving solenoid valves (36, 38) closed in idle state and are opened by a computer (C) on the basis of an output signal from a position or movement sensor (40) linked to the brake pedal or an element (20) moved by that pedal.

2. Installation according to claim 1, characterized in that the master cylinder (10) is a tandem master cylinder and comprises two pumping chambers (12, 14) that are each connected to the reservoir (30) by a solenoid valve (36, 38), each solenoid valve being open when the brake pedal or the element (20) moved by that pedal is in the idle or non-braking position, and being closed when the brake pedal or said element leaves the idle or non-braking position.

3. Installation according to claim 1, characterized in that the sensor (40) is a sensor for controlling illumination of the lamps of the brake signal circuits.
